(19) United States
(12) Patent Application Publication
(10) Pub. No.: US 2022/0146088 A1
(43) Pub. Date: May 12, 2022

(54) ILLUMINANT FLOWERPOT

(71) Applicant: Dongguan Lanhong Photoelectric Technology Co., LTD, Dongguan (CN)

(72) Inventor: Yelin Gong, Fuzhou (CN)

(21) Appl. No.: 17/585,511

(22) Filed: Jan. 26, 2022

(51) Int. Cl. F21V 33/00; F21V 19/00

(52) U.S. Cl. CPC F21V 33/0028; F21Y 2113/10; F21V 19/0015

(57) ABSTRACT

The invention discloses an illuminant flowerpot. The illuminant flowerpot comprises a first barrel, a second barrel and a light source. The first barrel is provided with a first bottom plate and a first circumferential side plate, and the first bottom plate and the first circumferential side plate enclose a first accommodation cavity opened upwards. The second barrel is provided with a second bottom plate and a second circumferential side plate, and the second bottom plate and the second circumferential side plate enclose a second accommodation cavity opened upwards. The second barrel is accommodated in the first accommodation cavity, a mounting gap is kept between the second bottom plate and the first bottom plate, and a light guide gap is kept between the second circumferential side plate and the first circumferential side plate.

### BACKGROUND OF THE INVENTION

### 1. Technical Field

The present invention relates to the field of flowerpots, in particular to an illuminant flowerpot.

### 2. Description of Related Art

There have been many flowerpots with light effects in an existing market. These flowerpots still have the defects of unreasonable design and poor light guide effect. Secondly, they also have problems in assembly.

Thus, it is necessary to research a novel technical scheme to solve the above-mentioned problem.

### BRIEF SUMMARY OF THE INVENTION

In order to overcome defects and shortcomings in the prior art, the present invention provides an illuminant flowerpot. By designing the illuminant flowerpot and forming the corresponding mounting gap and light guide gap in the flowerpot to further improve the light guide effect of the flowerpot, the ornamental aesthetic feeling of the flowerpot is improved. Meanwhile, the illuminant flowerpot has the advantages of being reasonable in design and convenient to assemble.

In order to realize the above-mentioned objective, the present invention adopts a technical scheme below: an illuminant flowerpot includes a first barrel, a second barrel and a light source, wherein the first barrel is provided with a first bottom plate and a first circumferential side plate, and the first bottom plate and the first circumferential side plate enclose a first accommodation cavity opened upwards;

the second barrel is provided with a second bottom plate and a second circumferential side plate, and the second bottom plate and the second circumferential side plate enclose a second accommodation cavity opened upwards;

the second barrel is accommodated in the first accommodation cavity, a mounting gap is kept between the second bottom plate and the first bottom plate, and a light guide gap is kept between the second circumferential side plate and the first circumferential side plate; and

the light source is arranged in the mounting gap, and the first barrel is made from a non-opaque material.

As a preferred scheme, a PCB and several lamp beads circumferentially arranged on the PCB are arranged in the mounting gap, and the lamp beads are located in a communication part of the mounting gap and the light guide gap; and the several lamp beads form the light source.

As a preferred embodiment, the lamp beads are RGB lamp beads.

As a preferred embodiment, a bottom end of the first circumferential side plate is connected to the first bottom plate, and an included angle between an inner wall surface of the first circumferential side plate and the first bottom plate ranges from 90 degrees to 120 degrees.

As a preferred embodiment, an inner side surface of the first circumferential side plate is circumferentially provided with a light guide ripple, and an outer side surface of the first circumferential side plate is circumferentially provided with a decorative ripple.

As a preferred embodiment, a landing edge extends circumferentially towards the outer side at an upper end of the second circumferential side plate; and

a baffle ring extends circumferentially towards the outer side at an upper end of the first circumferential side plate, and when the second barrel is accommodated in the first accommodation cavity, the landing edger and the baffle ring are connected in a clamped manner.

As a preferred embodiment, the second bottom plate of the second barrel is provided with a water outlet pipe, and the water outlet pipe extends to the outer side of the first barrel.

As a preferred embodiment, the first bottom plate is provided with a mounting compartment for mounting a battery upwards in a concave manner.

As a preferred embodiment, a lower side of the first bottom plate is selectively provided with a silica gel foot pad.

Compared with the prior art, the present invention has obvious advantages and beneficial effects. Specifically speaking, it can be known from the above-mentioned technical scheme that by primarily designing the illuminant flowerpot and forming the corresponding mounting gap and light guide gap in the flowerpot to further improve the light guide effect of the flowerpot, the ornamental aesthetic feeling of the flowerpot is improved. Meanwhile, the illuminant flowerpot has the advantages of being reasonable in design and convenient to assemble.

Secondly, the positions of the lamp beads are reasonable in design. The first circumferential side plate of the first barrel is designed skillfully, so that the ornamental effect of the flowerpot is further improved, and furthermore, the light show effect of light in the flowerpot is further improved.

In order to explain structural features and functions of the present invention more clearly, further description in detail on the present invention will be made in combination with drawings and specific embodiments below.

### BRIEF DESCRIPTION OF THE SEVERAL VIEWS OF THE DRAWINGS

FIG. 1 is a stereogram of an embodiment of the present invention.

FIG. 2 is a stereogram of an embodiment of the present invention at another angle.

FIG. 3 is an exploded view of an embodiment of the present invention.

FIG. 4 is a cross section diagram of an embodiment of the present invention.

FIG. 5 is a partial enlarged drawing of FIG. 4.

FIG. 6 is a stereogram of a first barrel in an embodiment of the present invention.

### DESCRIPTION OF NUMERALS IN DRAWINGS

10, first barrel; 11, first bottom plate; 111, mounting compartment; 12, first circumferential side plate; 121, baffle ring; 13, light guide ripple; 14, decorative ripple; 20, second barrel; 21, second bottom plate; 211, water outlet pipe; 22, second circumferential side plate; 221, landing edge; 30, mounting gap; 31, light guide gap; 32, insertion cavity; 40, PCB; 41, lamp bead; 50, silica gel foot pad.

### DETAILED DESCRIPTION OF THE INVENTION

Clear and intact description will be made on technical scheme in the embodiment of the present invention below in combination with drawings. Apparently, the described embodiments are merely preferred embodiments of the present invention.

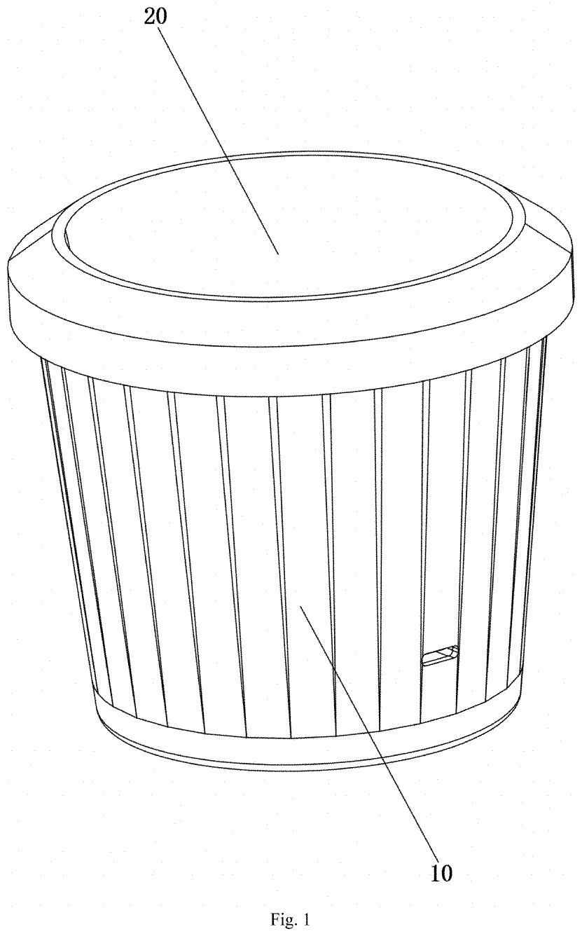

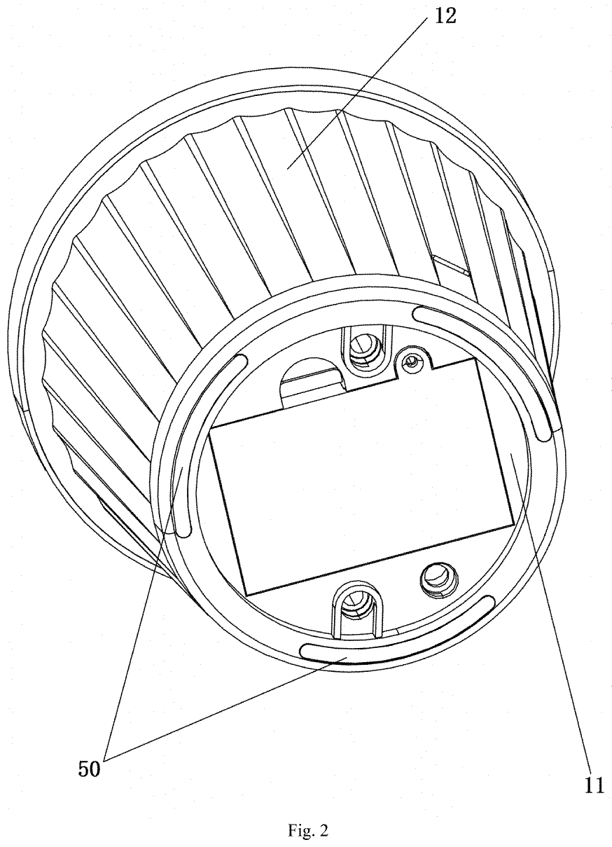

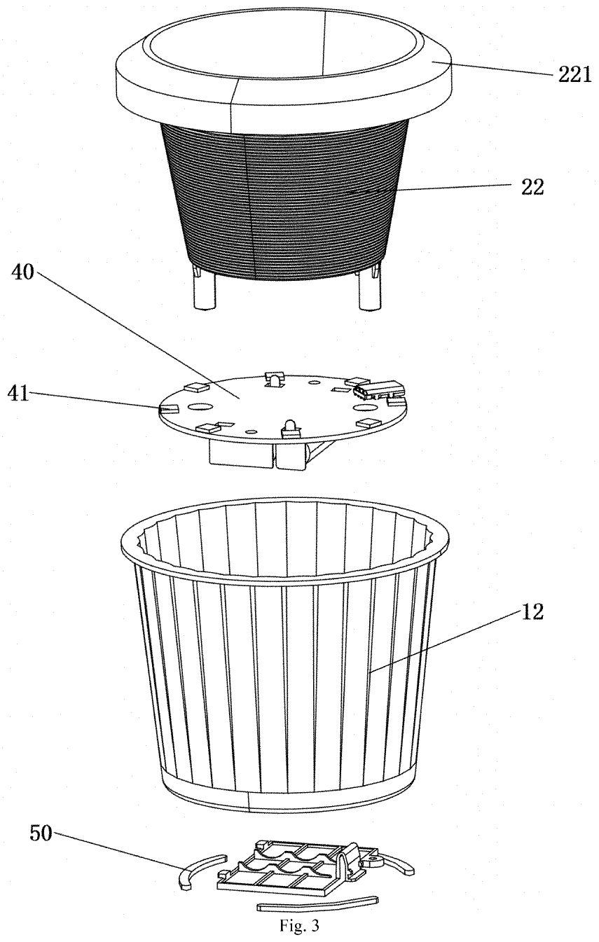

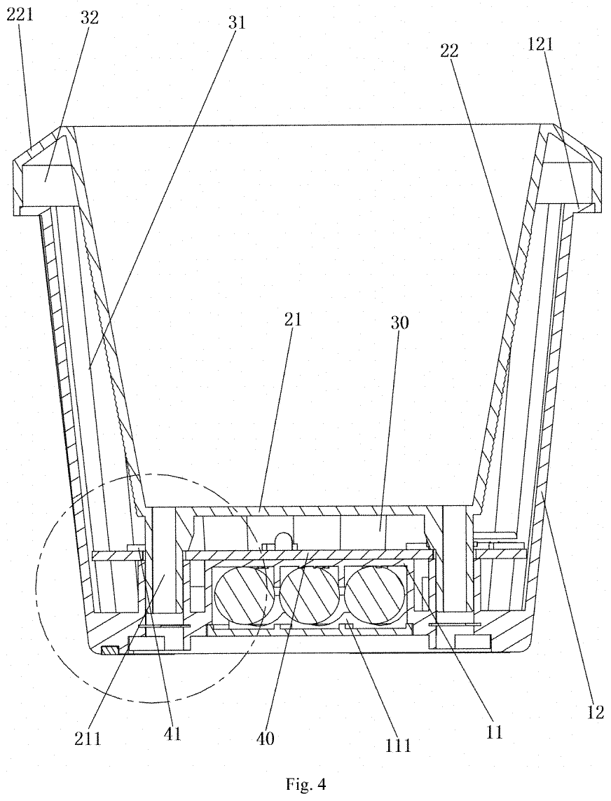

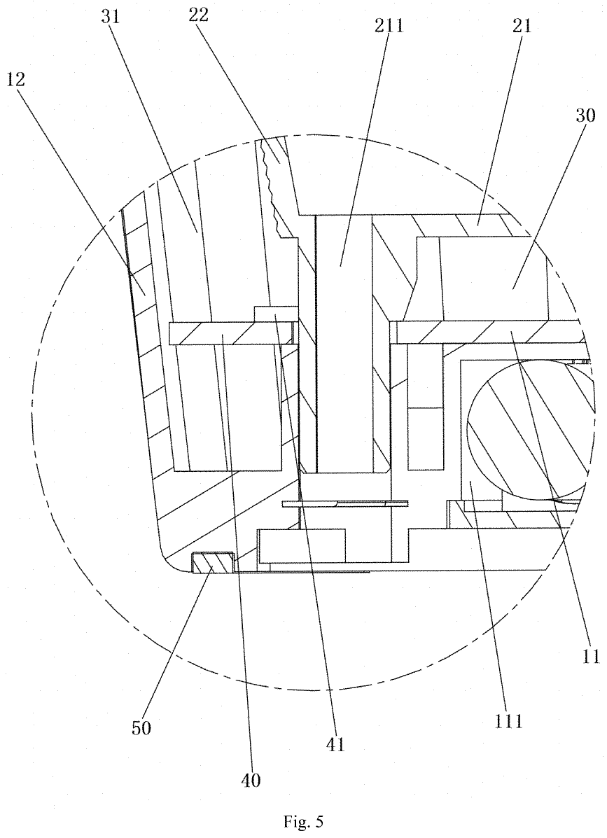

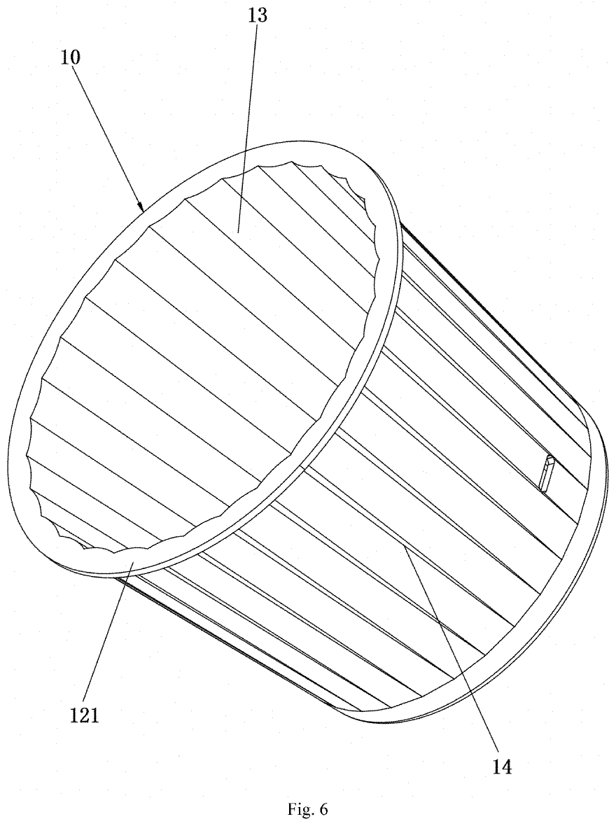

Referring to FIG. 1 to FIG. 6, an illuminant flowerpot in an embodiment of the present invention includes a first barrel 10, a second barrel 20 and a light source, wherein the first barrel 10 is provided with a first bottom plate 11 and a first circumferential side plate 12 arranged on the first bottom plate 11, and the first bottom plate 11 and the first circumferential side plate 12 enclose a first accommodation cavity opened upwards;

the second barrel 20 is provided with a second bottom plate 21 and a second circumferential side plate 22 arranged on the upper side of the second bottom plate 21, and the second bottom plate 21 and the second circumferential side plate 22 enclose a second accommodation cavity opened upwards;

the second barrel 20 is accommodated in the first accommodation cavity, a mounting gap 30 is kept between the second bottom plate 21 and the first bottom plate 11, and a light guide gap 31 is kept between the second circumferential side plate 22 and the first circumferential side plate 12; and

the light source is arranged in the mounting gap 30, and the first barrel 10 is made from a non-opaque material, preferably made from a white non-opaque material.

Thus, by designing the illuminant flowerpot and forming the corresponding mounting gap 30 and light guide gap 31 in the flowerpot to further improve the light guide effect of the flowerpot, the ornamental aesthetic feeling of the flowerpot is improved. Meanwhile, the illuminant flowerpot has the advantages of being reasonable in design and convenient to assemble.

Preferably, the first barrel 10 and the second barrel 20 are cylindrical.

Specifically speaking, a PCB 40 and several lamp beads 41 circumferentially arranged on the PCB 40 are arranged in the mounting gap 30, and the lamp beads 41 are located in a communication part of the mounting gap 30 and the light guide gap 31; and the several lamp beads 41 form the light source. Usually, the lamp beads 41 are RGB lamp beads 41. Thus, the lamp beads 41 are reasonably arranged at the communicating part of the mounting gap 30 and the light guide gap 31, rays are prevented from being stopped by other components, so that rays sent by the lamp beads 41 can be well projected to the first circumferential side plate 12 of the first barrel 10.

Preferably, a bottom end of the first circumferential side plate 12 is connected to the first bottom plate 11, and an included angle between an inner wall surface of the first circumferential side plate 12 and the first bottom plate 11 ranges from 90 degrees to 120 degrees. Therefore, an advantage of being convenient to mount the second barrel 20 is achieved; furthermore, an inner side surface of the first circumferential side plate 12 is circumferentially provided with a light guide ripple 13, and an outer side surface of the first circumferential side plate 12 is circumferentially provided with a decorative ripple 14. Preferably, the included angle between the inner wall surface of the first circumferential side plate 12 and the first bottom plate 11 is 120 degrees, so that the light guide ripple 13 can be projected intact by the rays sent by the lamp beads 41. Usually, the light guide bumps can be several raised lines arranged at an interval.

Preferably, the second circumferential side plate 22 of the second barrel 20 is further gradually expanded outwards to form an outward expanded upper side opening, through which plants and soil enter the second accommodation cavity conveniently.

Preferably, a landing edge 221 extends circumferentially towards the outer side at an upper end of the second circumferential side plate 22; a baffle ring 121 extends circumferentially towards the outer side at an upper end of the first circumferential side plate 12, and when the second barrel 20 is accommodated in the first accommodation cavity, the landing edger 221 and the baffle ring 121 are connected in a clamped manner. Thus, an assembled structure of the first barrel 10 and the second barrel 20 is further optimized. Meanwhile, the landing edge 221 and the baffle ring 121 enclose the insertion cavity 32. In an actual application, the upper side of the landing edge 221 can be annularly provided with several insertion holes for inserting petals.

Further, the second bottom plate 21 of the second barrel 20 is provided with a water outlet pipe 211, and the water outlet pipe 211 extends to the outer side of the first barrel 10. Preferably, the water outlet pipe 211 extends to the lower side of the first bottom plate 11 of the first barrel 10. Further, the first bottom plate 11 is provided with a mounting compartment 111 for mounting a battery upwards in a concave manner. Usually, the battery is in power supply connection to the lamp beads 41. Preferably, the first barrel 10 is further provided with a USB port. The USB port can be a Type-c port.

Preferably, the lower side of the first bottom plate 11 is selectively provided with a silica gel foot pad 50. Usually, a contact convex ring extends downwards on the first bottom plate 11, the contact convex ring is upwards provided with a mounting groove in a concave manner, and the silica gel foot pad 50 is arranged on the mounting groove through glue. Usually, there are three mounting grooves formed along the circumferential direction of the first bottom plate 11 at an interval, and each mounting groove is provided with the silica gel foot pad 50.

A design key point of the present invention lies in that by designing the illuminant flowerpot and forming the corresponding mounting gap and light guide gap in the flowerpot to further improve the light guide effect of the flowerpot, the ornamental aesthetic feeling of the flowerpot is improved. Meanwhile, the illuminant flowerpot has the advantages of being reasonable in design and convenient to assemble.

Secondly, the positions of the lamp beads are reasonable in design. The first circumferential side plate of the first barrel is designed skillfully, so that the ornamental effect of the flowerpot is further improved, and furthermore, the light show effect of light in the flowerpot is further improved.

The above is merely preferred embodiments of the present invention and is not limitation to the technical scope of the present invention. Any subtle modifications, equivalent changes and modifications made on the embodiments in accordance with the technical substance of the present invention shall come within the scope of the technical scheme of the present invention.

What is claimed is:

1. An illuminant flowerpot, characterized by comprising a first barrel, a second barrel and a light source, wherein the first barrel is provided with a first bottom plate and a first circumferential side plate, and the first bottom plate and the first circumferential side plate enclose a first accommodation cavity opened upwards;
the second barrel is provided with a second bottom plate and a second circumferential side plate, and the second bottom plate and the second circumferential side plate enclose a second accommodation cavity opened upwards;
the second barrel is accommodated in the first accommodation cavity, a mounting gap is kept between the second bottom plate and the first bottom plate, and a light guide gap is kept between the second circumferential side plate and the first circumferential side plate; and
the light source is arranged in the mounting gap, and the first barrel is made from a non-opaque material.

2. The illuminant flowerpot according to claim 1, characterized in that a PCB and several lamp beads circumferentially arranged on the PCB are arranged in the mounting gap, and the lamp beads are located in a communication part of the mounting gap and the light guide gap; and the several lamp beads form the light source.

3. The illuminant flowerpot according to claim 2, characterized in that the lamp beads are RGB lamp beads.

4. The illuminant flowerpot according to claim 2, characterized in that a bottom end of the first circumferential side plate is connected to the first bottom plate, and an included angle between an inner wall surface of the first circumferential side plate and the first bottom plate ranges from 90 degrees to 120 degrees.

5. The illuminant flowerpot according to claim 4, characterized in that an inner side surface of the first circumferential side plate is circumferentially provided with a light guide ripple, and an outer side surface of the first circumferential side plate is circumferentially provided with a decorative ripple.

6. The illuminant flowerpot according to claim 2, characterized in that a landing edge extends circumferentially towards the outer side at an upper end of the second circumferential side plate; and a baffle ring extends circumferentially towards the outer side at an upper end of the first circumferential side plate, and when the second barrel is accommodated in the first accommodation cavity, the landing edger and the baffle ring are connected in a clamped manner.

7. The illuminant flowerpot according to claim 2, characterized in that the second bottom plate of the second barrel is provided with a water outlet pipe, and the water outlet pipe extends to the outer side of the first barrel.

8. The illuminant flowerpot according to claim 2, characterized in that the first bottom plate is provided with a mounting compartment for mounting a battery upwards in a concave manner.

9. The illuminant flowerpot according to claim 8, characterized in that a lower side of the first bottom plate is selectively provided with a silica gel foot pad.
